(19) United States
(12) Patent Application Publication
(10) Pub. No.: US 2005/0062847 A1
(43) Pub. Date: Mar. 24, 2005

(54) Viewing device

(76) Inventor: Francis Alan Johnston, Ciane (IE)

Correspondence Address: JACOBSON HOLMAN PLLC, 400 SEVENTH STREET N.W., SUITE 600, WASHINGTON, DC, 20004, US

(21) Appl. No.: 10/865,907

(22) Filed: Jun. 14, 2004

(30) Foreign Application Priority Data
Jun. 17, 2003 (IE) 2003/0445

(51) Int. Cl. H04N 7/18; H04N 9/47

(52) U.S. Cl. 348/62

(57) ABSTRACT

A handheld viewing device (1) comprises an electronic camera (2) housed in a camera part (7) for capturing a visual image of text on a page, and an electronic monitor (3) housed in a monitor part (4) for displaying the visual image of the text. The camera part (7) is pivotably movable relative to the monitor part (4) from a stowed configuration to a reading configuration, and further to a writing configuration. In the stowed configuration, the plane of the camera part (7) is substantially co-planar with the plane of the monitor part (4), and thus the device (1) presents a very low-profile compact size and shape. In the reading configuration, the camera (2) points in the direction of the page, and the camera part (7) is spaced above the page to ensure that there is sufficient distance between the camera (2) and the page to enable the camera (2) to capture the visual image of the text. In the writing configuration, the camera (2) is still pointed in the direction of the page but slightly outwards to enable a user to place the tip of a pen within the view of the camera (2).

The invention relates to a viewing device. In particular, this invention relates to a viewing device for use, for example, by a visually impaired person to assist in reading.

It is known to employ a closed circuit television system to assist a visually impaired person while reading. Such systems typically include a camera positioned above a page of text to capture a visual image of the text, and a monitor to display the captured visual image. However, such systems are generally large and cumbersome.

This invention is therefore aimed at overcoming at least some of the problems associated with the known systems.

### STATEMENTS OF INVENTION

According to the invention there is provided a handheld viewing device comprising:
a capture element for capturing a visual image of at least part of a surface; and
a display element for displaying a visual image;
the capture element being movable relative to the display element between a stowed configuration and at least one capturing configuration.

In one embodiment of the invention the display element comprises:
a base side for placement against the surface; and
a display side for displaying the visual image;
in the at least one capturing configuration, the capture element being located further from the base side than in the stowed configuration.

In the capturing configuration, by spacing the capturing means above the base side, this creates the required distance between the capturing means and the surface to enable the desired visual image of the surface to be captured.

Preferably in the stowed configuration, a first side of the capture element lies substantially in the plane of the base side. Because the capturing means is flush with the base side in the stowed configuration, this ensures that the viewing device presents a compact, low-profile while in the stowed configuration. Having a distance between the capturing means and the surface is not necessary when the device is in the stowed configuration. Ideally in the stowed configuration, a second side of the capture element lies substantially in the plane of the display side. Most preferably the display side is provided on the opposite side of the display element to the base side.

In one case the display element is substantially planar. The capture element may be substantially planar. Preferably in the stowed configuration, the plane of the capture element is substantially co-planar with the plane of the display element. The co-planar nature of the viewing device further enhances the compactness of the device. Ideally in the at least one capturing configuration, the plane of the capture element is substantially out-of-plane with respect to the plane of the display element.

In another embodiment the capture element is movable relative to the display element between the stowed configuration and a reading capturing configuration, and between the stowed configuration and a writing capturing configuration. Because the capturing means can be moved into both a reading configuration and a writing configuration, the viewing device enables a user to both read using the device and write using the device. The capturing means can be quickly and easily moved between the reading configuration and the writing configuration, thus the user can quickly and easily switch between the acts of reading and writing. In this manner, the viewing device of the invention provides a visually impaired person with the opportunity to switch between reading and writing in a natural manner. The capture element may be pivotably movable relative to the display element. Preferably the pivot axis is substantially parallel to the plane of the display element. Ideally the pivot axis is located closer to the display side than to the base side. By locating the pivot axis close to the display side, this ensures that the capturing means will pivot up, away from the base side to create the required distance between the capturing means and the surface to enable the desired visual image of the surface to be captured.

In one case the capture element is pivotable relative to the display element through an angle of approximately 90 degrees from the stowed configuration to the reading configuration. The capture element may be pivotable relative to the display element through an angle of greater than 90 degrees from the stowed configuration to the writing configuration. The capture element may be pivotable relative to the display element through an angle of approximately 135 degrees from the stowed configuration to the writing configuration. By pivoting the capturing means further to the writing configuration, this enables a writing implement, such as a pen, to be located between the capture element and the surface. Thus the user can then view on the display means what is being written.

In another preferred embodiment the device comprises an activate/deactivate element for activating and/or deactivating the capture element and/or the display element. The activate/deactivate element may comprise a user interface control. Preferably the activate/deactivate element comprises at least one switch. Ideally the activate/deactivate element is configured to be triggered responsive to the capture element being moved relative to the display element between the stowed configuration and the at least one capturing configuration. This arrangement ensures that the device is activated automatically as soon as the capturing means is moved from the stowed configuration into the capturing configuration. The capture element may comprise at least one protrusion for engaging the switch to trigger the switch upon movement relative to the display element. Most preferably the protrusion comprises a cam-shaped arm.

The capture element may be detachably mounted to the display element.

In one case the device comprises a communications system to facilitate communication between the capture element and the display element. Preferably the communications system is configured to facilitate wireless communication between the capture element and the display element. The communications system may comprise a connecting lead.

In a preferred case the display element is configured to display the captured visual image.

In another case the display element is configured to display a visual image derived from the captured visual image. Preferably the device comprises a processor configured to magnify the captured visual image before display. By magnifying the image, a visually impaired person will be better able to read the image. Ideally the device comprises a processor configured to alter the captured visual image before display.

The capture element preferably comprises a camera. Ideally the camera comprises an electronic camera.

The display element preferably comprises an electronic monitor. Ideally the display element comprises a housing, the monitor being movable relative to the housing between a stowed configuration and a viewing configuration. Thus the user can adjust the monitor to a desired viewing configuration for ease of viewing the monitor. In particular the user does not have to lean over the monitor to view it. Most preferably the monitor is pivotably movable relative to the housing.

In a preferred case the device is portable. The device may be configured to be carried in a pocket. Ideally the device is sized to be carried in a pocket. The portable nature of the viewing device provides for ease of use. A visually impaired person can simply carry the device with them, for example in a pocket, so that the device is available for use by the visually impaired person whenever required.

In one case the device comprises a source of power for the capture element and/or for the display element, the power source being carried by the device. Preferably the power source is rechargeable. Ideally the power source is accessible by an external charger to recharge the power source. The power source may be fixed in position relative to the device. Most preferably the power source is housed within at least part of the device. In a preferred case the power source comprises a high capacity battery.

In another aspect the invention provides a viewing device comprising:
a capture element for capturing a visual image of at least part of a surface; and
a display element for displaying a visual image;
the capture element being movable relative to the display element between a stowed configuration and a reading configuration; and
the capture element being movable relative to the display element between the stowed configuration and a writing configuration.

The invention provides in a further aspect a viewing device comprising:
a capture element for capturing a visual image of at least part of a surface; and
a display element for displaying a visual image;
the display element comprising:
   a base side for placement against the surface; and
   a display side for displaying the visual image;
the capture element being movable relative to the display element between a stowed configuration and at least one capturing configuration;
in the stowed configuration, a side of the capture element lying substantially in the plane of the base side; and
in the at least one capturing configuration, the capture element being located further from the base side than in the stowed configuration.

### BRIEF DESCRIPTION OF THE DRAWINGS

The invention will be more clearly understood from the following description of some embodiments thereof, given by way of example only, with reference to the accompanying drawings, in which:—

FIG. 1 is a top plan view of a viewing device according to the invention;

FIG. 2 is a view along line II-II in FIG. 1;

FIG. 3 is a view along line III-III in FIG. 1;

FIG. 4 is an exploded, perspective view of the device of FIG. 1;

FIG. 5 is a perspective view from above of the device of FIG. 1 in a stowed configuration;

FIG. 6 is a perspective view from below of the device of FIG. 1 in the stowed configuration;

FIG. 7 is a perspective view from above of the device of FIG. 1 in a reading configuration;

FIG. 8 is a perspective view from below of the device of FIG. 1 in the reading configuration;

FIG. 9 is a perspective view from above of the device of FIG. 1 in a writing configuration;

FIG. 10 is a perspective view from below of the device of FIG. 1 in the writing configuration;

FIG. 11 is an exploded, perspective view of another viewing device according to the invention;

FIG. 12 is an enlarged, exploded, perspective view of a part of the device of FIG. 11;

FIG. 13 is an enlarged, perspective view of another part of the device of FIG. 11;

FIG. 14 is a perspective view of the device of FIG. 11 partially assembled;

FIG. 15 is a perspective view of a part of another viewing device according to the invention;

FIG. 16(a) is a perspective view of a further viewing device according to the invention in a stowed configuration;

FIG. 16(b) is a perspective view of the device of FIG. 16(a) in a reading configuration; and

FIGS. 17 and 18 are perspective views of other viewing devices according to the invention.

### DETAILED DESCRIPTION

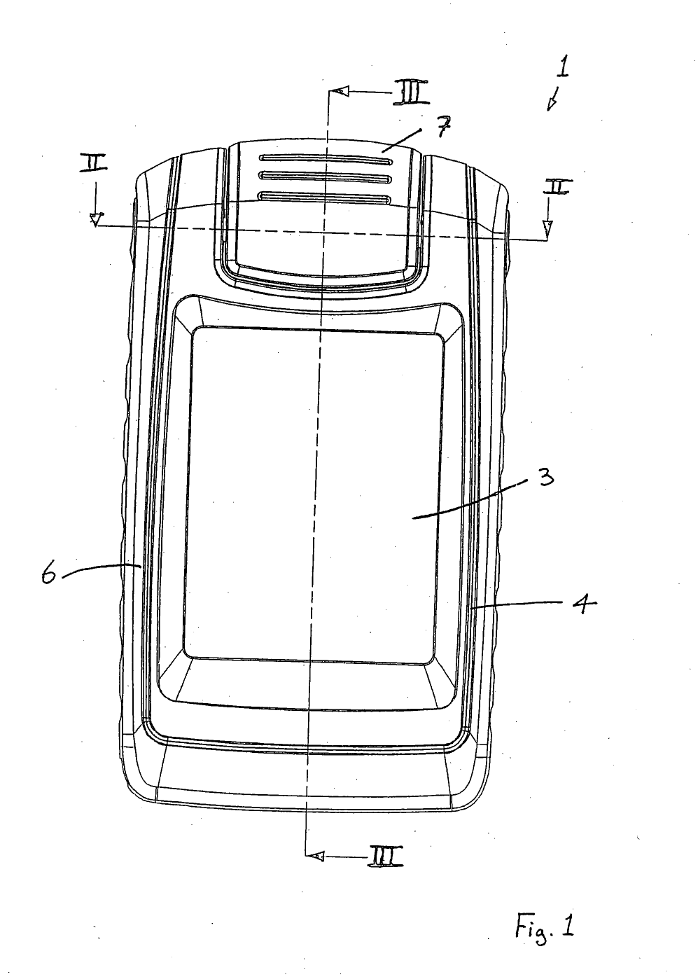

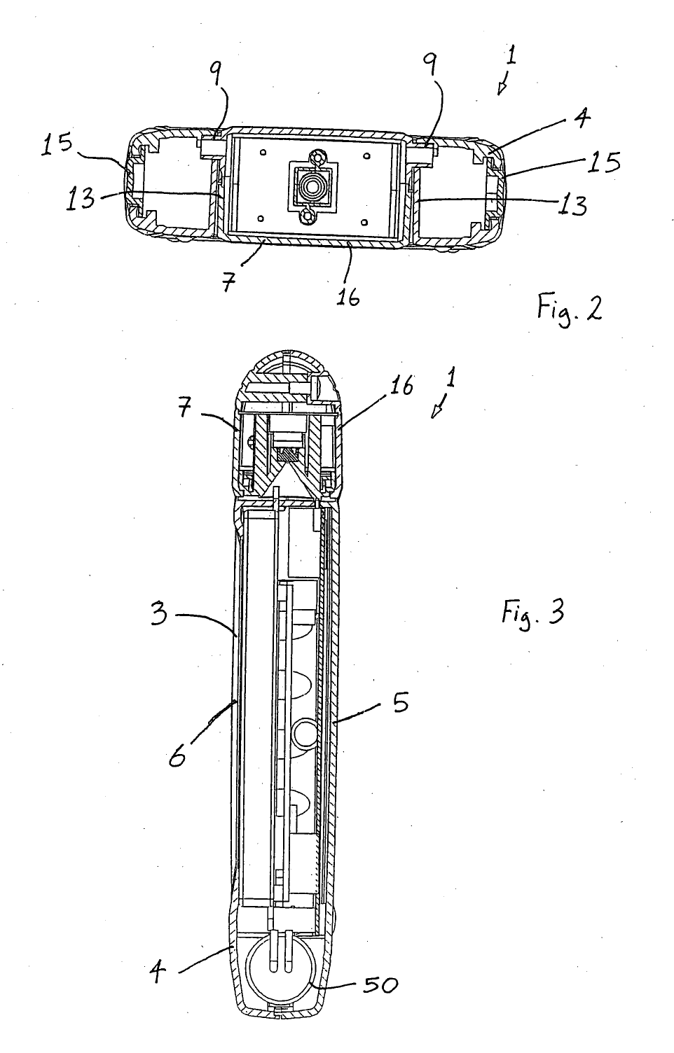

Referring to the drawings, and initially to FIGS. 1 to 10 thereof, there is illustrated a handheld, portable viewing device 1 according to the invention. The device 1 comprises means to capture a visual image of at least part of a surface, for example to capture the visual image of text on a page, and means to display a visual image. The visual image displayed may be the captured visual image, or alternatively the visual image displayed may be an image which is derived from the captured visual image.

In this case, the capturing means is provided in the form of an electronic camera 2 housed in a camera part 7. The display means is provided in the form of an electronic monitor 3, such as a flat panel display monitor, housed in a monitor part 4.

As illustrated in FIG. 3, the monitor part 4 comprises a base side 5 suitable for placement, in use, against the surface of the page, and a display side 6 for displaying the captured visual image. The display side 6 is provided on the opposite side of the monitor part 4 to the base side 5. The monitor part 4 has an opening 8 on the display side 6, as illustrated in FIG. 4, to enable a user to view the electronic monitor 3.

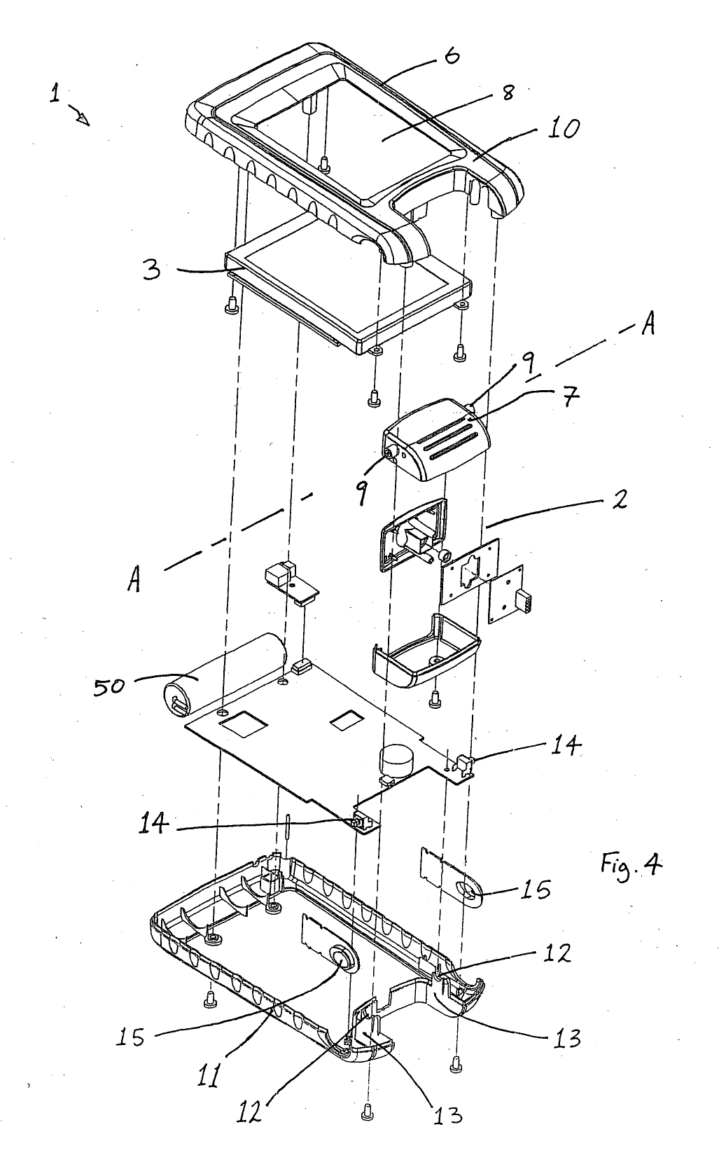

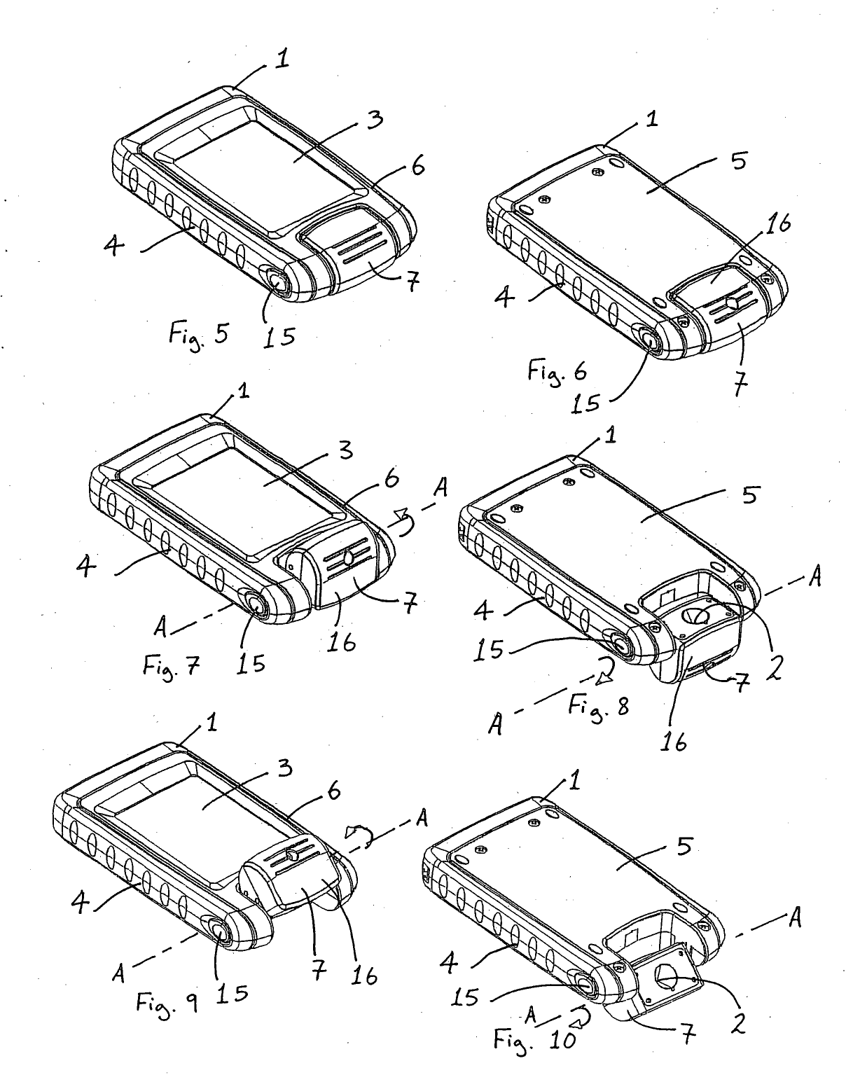

The camera part 7 is pivotably movable relative to the monitor part 4 from a stowed configuration (FIGS. 5 and 6) through an angle of approximately 90 degrees to a reading configuration (FIGS. 7 and 8), and through a further angle of approximately 45 degrees to a writing configuration (FIGS. 9 and 10).

To facilitate this pivoting movement, the camera part 7 comprises two outwardly protruding cylindrical arms 9 which are received in co-operating circular openings 12 formed between an upper part 10 of the monitor part 4 and a lower part 11 of the monitor part 4, as illustrated in FIG. 4. The arms 9 are rotatable in these circular openings 12 to enable the pivoting movement of the camera part 7 relative to the monitor part 4. The arms 9 protrude outwardly parallel to the plane of the monitor part 4 so that the axis of pivoting A-A of the camera part 7 is parallel to the plane of the monitor part 4. The openings 12 are provided at the top end of two columns 13 which extend upwards from the lower part 11 of the monitor part 4. The pivot axis A-A is thus closer to the display side 6 than to the base side 5.

The camera 2 and/or the monitor 3 are automatically activated as the camera part 7 pivots from the stowed configuration to the reading configuration, and are automatically deactivated as the camera part 7 pivots from the reading configuration to the stowed configuration.

To alter the way the visual image is displayed by the monitor 3, two switches 14 are provided. The switches 14 may be triggered by depressing two corresponding buttons 15 to change the colour of the visual image, and/or to make the visual image monochrome, and/or to invert the visual image. In this manner the user is provided with a degree of control over the visual image displayed by the monitor 3.

In the stowed configuration, the plane of the camera part 7 is substantially co-planar with the plane of the monitor part 4, as illustrated in FIGS. 5 and 6. Furthermore the bottom side 16 of the camera part 7 lies in the same plane as the base side 5, and the top side of the camera part 7 lies in the same plane as the display side 6 (FIG. 6). Thus the device 1 presents a very low-profile compact size and shape when in the stowed configuration. The device 1 is suitable therefore for being carried by a user, for example, in a pocket.

In the reading configuration, the plane of the camera part 7 is substantially out-of-plane with respect to the plane of the monitor part 4, with the camera 2 pointing in the direction of the page to enable the visual image of the text to be captured, as illustrated in FIGS. 7 and 8. In addition, the camera part 7 is located further from the base side 5 than in the stowed configuration. In particular the camera part 7 is spaced above the base side 5 and above the page (FIG. 8) to ensure that there is sufficient distance between the camera 2 and the page to enable the camera 2 to capture the visual image of the text.

In the writing configuration, the camera 2 is still pointed in the direction of the page but slightly outwards, as illustrated in FIGS. 9 and 10. This enables a user to place the tip of a writing instrument, such as a pen, within the view of the camera 2. The viewing device 1 can thus be used to display on the monitor 3 what the user is writing.

The camera part 7 is also spaced above the base side 5 and above the page in the writing configuration (FIG. 10).

A power source is provided for the camera 2 and the monitor 3. In this case the power source is provided in the form of a single cell rechargeable battery 50 carried by the device 1. The battery 50 is housed within the monitor part 4 between the lower part 11 of the monitor part 4 and the upper part 10 of the monitor part 4, as illustrated in FIG. 4. By housing the battery 50 within the monitor part 4 in this way, it is not possible for a user to inadvertently remove, damage or interfere with the battery 50, when the device 1 is assembled.

The battery 50 is positioned within the monitor part 4 in a suitable manner to facilitate access by an external charger to recharge the battery 50.

Because the power source for the camera 2 and the monitor 3 is carried by the device 1, this ensures that the device 1 is highly portable.

In addition the battery 50 is a high capacity battery. Thus the overall size of the battery 50 may be minimised for a given amount of energy stored in the battery 50. By minimising the size and weight of the battery 50, the portable nature of the device 1 is further enhanced.

It will be appreciated that the viewing device 1 may comprise means to magnify the visual image of the text, which is captured by the camera 2, before the visual image is displayed on the monitor 3. This magnification aspect of the device 1 is especially advantageous for displaying the visual image to a visually impaired person who may otherwise find difficulty in reading the unmagnified text.

In use, the device 1 is placed on a page of text with the base side 5 resting on the page. The camera part 7 is pivoted by a user relative to the monitor part 4 from the stowed configuration (FIGS. 5 and 6) to the reading configuration (FIGS. 7 and 8) to automatically activate the camera 2 and the monitor 3. The user can then move the device 1 across the page of text while reading the displayed text from the monitor 3.

The camera part 7 may be pivoted further from the reading configuration to the writing configuration (FIGS. 9 and 10). The user can then point the camera 2 towards the place on the page where the user is writing. In this way the user can read what is being written from the monitor 3.

The camera part 7 may be quickly and easily moved from the reading configuration to the writing configuration, and vice versa, to enable the user to change from reading to writing, and vice versa, in a natural manner.

When the user is finished using the device 1, the camera part 7 is pivoted relative to the monitor part 4 to the stowed configuration to automatically deactivate the camera 2 and the monitor 3. The device 1 can then be carried, for example, in the user's pocket.

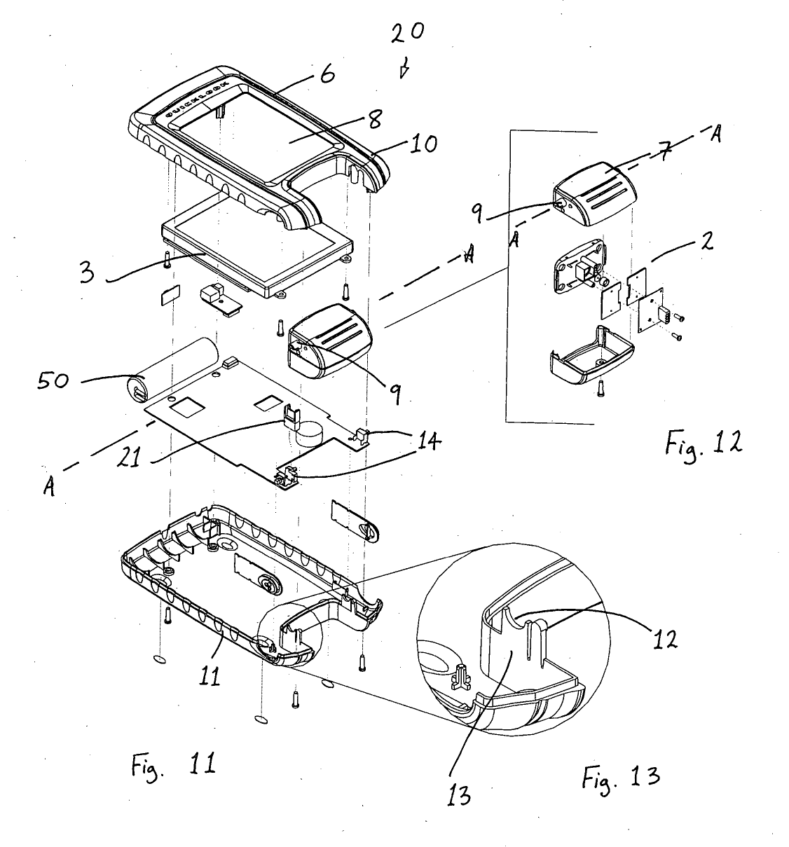

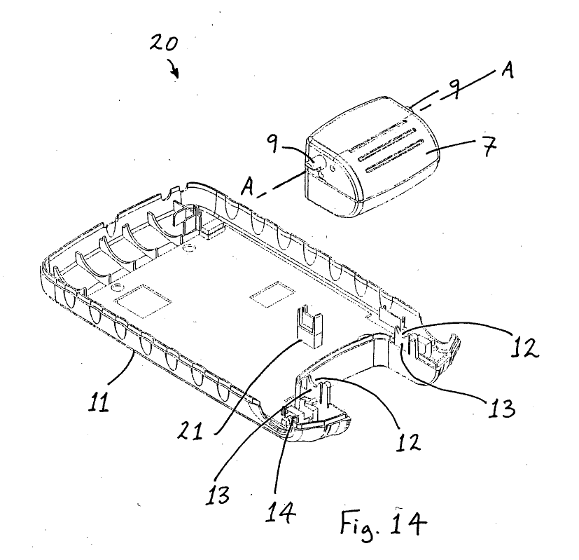

In FIGS. 11 to 14 there is illustrated another viewing device 20 according to the invention, which is similar to the device 1 of FIGS. 1 to 10, and similar elements in FIGS. 11 to 14 are assigned the same reference numerals.

In this case the arms 9 are cam-shaped, and are configured to engage with a plunger 21 in a co-operating manner as the camera part 7 is pivoted from the stowed configuration to the reading configuration. When the cam-shaped arm 9 engages the plunger 21, this causes the plunger 21 to be forced downwardly and to thereby trigger the switch 14 to activate and/or deactivate the camera 2 and/or the monitor 3. In this way, the device 20 is activated/deactivated automatically as the camera part 7 pivots between the stowed configuration and the reading configuration.

It will be appreciated that the switching mechanism employed to enable the device to be automatically activated/deactivated as the camera part 7 pivots between the stowed configuration and the reading configuration may be provided in a variety of different means. For example breaking of an optical beam may be used to trigger the switch. Alternatively other physical switch and actuator arrangements would be employed to trigger the switch.

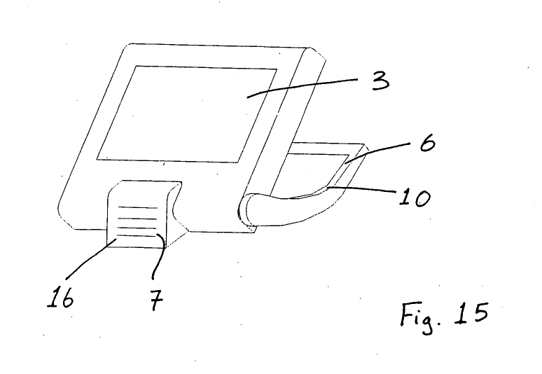

The monitor 3 may be provided pivotably movable relative to the upper part 10 of the monitor part 4, as illustrated in FIG. 15. By arranging the monitor 3 to be movable, this enables the user to position the monitor 3 in a desired viewing configuration, while maintaining the camera part 7 in the reading configuration with the camera 2 facing downwards (FIG. 15). It is therefore not necessary for the user to lean over the monitor 3 to view the displayed visual image. When the user is finished using the device, the monitor 3 could then be moved to a low-profile stowed configuration flat against the upper part 10 to ensure that the device is compact for storage and/or carrying.

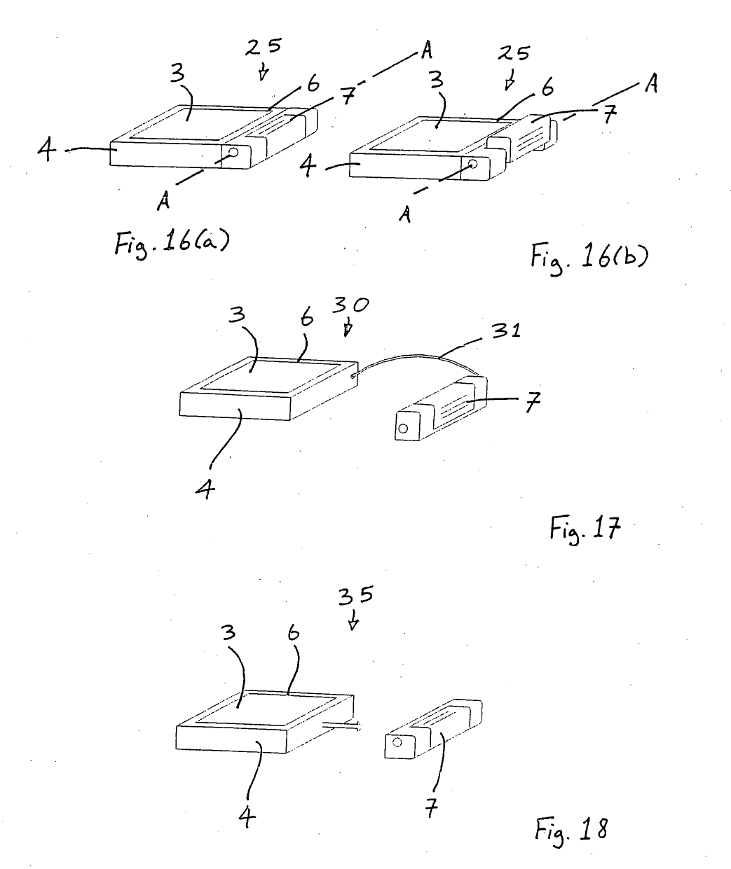

Referring to FIGS. 16(a) and 16(b) there is illustrated another viewing device 25 according to the invention, which is similar to the device 1 of FIGS. 1 to 10, and similar elements in FIGS. 16(a) and 16(b) are assigned the same reference numerals.

FIG. 17 illustrates a further viewing device 30 according to the invention, which is similar to the device 25 of FIGS. 16(a) and 16(b), and similar elements in FIG. 17 are assigned the same reference numerals.

In this case, the camera part 7 is detachable from the monitor part 4. The user therefore only needs to hold and manipulate the camera part 7 which is relatively light in weight. Also the camera part 7 may be tilted outwards to facilitate writing.

A connecting lead 31 is provided to connect the camera part 7 to the monitor part 4, and thus facilitate electronic communication between the camera part 7 and the monitor part 4.

In FIG. 18 there is illustrated another viewing device 35 according to the invention, which is similar to the device 30 of FIG. 17, and similar elements in FIG. 18 are assigned the same reference numerals.

In this case, both the camera part 7 and the monitor part 4 are configured to facilitate wireless communication between the camera part 7 and the monitor part 4.

In the embodiments described above with reference to FIGS. 1 to 18, the camera part 7 is pivotably mounted to the monitor part 4 along one of the shorter sides of the rectangular monitor part 4. It will be appreciated that the camera part 7 may alternatively be pivotably mounted to the monitor part 4 along one of the longer sides of the rectangular monitor part 4.

This results in the defining thickness being the smaller of the dimensions of the camera part 7.

The camera 2 has a sensor size of 1/4 inch and is mounted above a lens in a manner that allows the camera 2 to view a small area of the order of, but not necessarily limited to, 15 mm×20 mm. The focal length of the lens is of the order of 3 mm to 4 mm, and is preferably approximately 3.4 mm. It has been found that lenses with shorter focal lengths tend to introduce severe barrel distortion or are increasingly expensive.

A relatively small aperture, in this case about f8, is employed to give an increased depth of field.

It can be calculated that the required distance from an object, such as print text on flat paper, to the image sensor is approximately 33 mm. Add to this the depth of the camera 2 behind the sensor surface, which is typically 10 to 15 mm, then the total height of the camera 2 above the object is about 45 mm. This distance would be greater than desirable for a pocket sized viewing device.

With the viewing device of the invention in suit, the following advantages can be observed:

The space below the camera part 7 is only required when the viewing device is in use. The camera module dimensions are substantially smaller than the 45 mm mentioned above (typically of the order of 22×26 mm)

The camera/lens part 7 is mounted to the monitor part 4 so that it can rotate about the pivot axis A-A in such a way that when it is stowed for transport, it “looks” sideways toward the monitor part 4 of the viewing device. Therefore in this position, its governing dimension is the camera module length.

Because the pivot axis A-A is offset above the centreline of the viewing device, the camera/lens part 7 rises up from the paper as it is rotated up to the reading configuration, thereby achieving the required distance between the camera 2 and the paper.

A further improvement can be obtained by allowing the camera/lens part 7 to rotate further so that the camera 2 can look out slightly to the side. This will allow a pen to be used under the viewing device for handwriting. The depth of field achieved by using a small aperture allows the camera 2 to display an acceptable image despite the focal arrangement of the lens being unaltered.

The invention provides a small pocket sized magnifier with several features that make it very suitable especially for the visually impaired.

The invention is not limited to the embodiments hereinbefore described, with reference to the accompanying drawings, which may be varied in construction and detail.

1. A handheld viewing device comprising:
a capture element for capturing a visual image of at least part of a surface; and
a display element for displaying a visual image;
the capture element being movable relative to the display element between a stowed configuration and at least one capturing configuration.

2. A device as claimed in claim 1 wherein the display element comprises:
a base side for placement against the surface; and
a display side for displaying the visual image;
in the at least one capturing configuration, the capture element being located further from the base side than in the stowed configuration.

3. A device as claimed in claim 2 wherein in the stowed configuration, a first side of the capture element lies substantially in the plane of the base side.

4. A device as claimed in claim 2 wherein in the stowed configuration, a second side of the capture element lies substantially in the plane of the display side.

5. A device as claimed in claim 2 wherein the display side is provided on the opposite side of the display element to the base side.

6. A device as claimed in claim 1 wherein the display element is substantially planar.

7. A device as claimed in claim 1 wherein the capture element is substantially planar.

8. A device as claimed in claim 1 wherein in the stowed configuration, the plane of the capture element is substantially co-planar with the plane of the display element.

9. A device as claimed in claim 1 wherein in the at least one capturing configuration, the plane of the capture element is substantially out-of-plane with respect to the plane of the display element.

10. A device as claimed in claim 1 wherein the capture element is movable relative to the display element between the stowed configuration and a reading capturing configuration, and between the stowed configuration and a writing capturing configuration.

11. A device as claimed in claim 1 wherein the capture element is pivotably movable relative to the display element.

12. A device as claimed in claim 11 wherein the pivot axis is substantially parallel to the plane of the display element.

13. A device as claimed in claim 11 wherein the pivot axis is located closer to the display side than to the base side.

14. A device as claimed in claim 11 wherein the capture element is pivotable relative to the display element through an angle of approximately 90 degrees from the stowed configuration to the reading configuration.

15. A device as claimed in claim 11 wherein the capture element is pivotable relative to the display element through an angle of greater than 90 degrees from the stowed configuration to the writing configuration.

16. A device as claimed in claim 15 wherein the capture element is pivotable relative to the display element through an angle of approximately 135 degrees from the stowed configuration to the writing configuration.

17. A device as claimed in claim 1 wherein the device comprises an activate/deactivate element for activating and/or deactivating the capture element and/or the display element.

18. A device as claimed in claim 17 wherein the activate/deactivate element comprises a user interface control.

19. A device as claimed in claim 17 wherein the activate/deactivate element comprises at least one switch.

20. A device as claimed in claim 17 wherein the activate/deactivate element is configured to be triggered responsive to the capture element being moved relative to the display element between the stowed configuration and the at least one capturing configuration.

21. A device as claimed in claim 20 wherein the capture element comprises at least one protrusion for engaging the switch to trigger the switch upon movement relative to the display element.

22. A device as claimed in claim 21 wherein the protrusion comprises a cam-shaped arm.

23. A device as claimed in claim 1 wherein the capture element is detachably mounted to the display element.

24. A device as claimed in claim 1 wherein the device comprises a communications system to facilitate communication between the capture element and the display element.

25. A device as claimed in claim 24 wherein the communications system is configured to facilitate wireless communication between the capture element and the display element.

26. A device as claimed in claim 24 wherein the communications system comprises a connecting lead.

27. A device as claimed in claim 1 wherein the display element is configured to display the captured visual image.

28. A device as claimed in claim 1 wherein the display element is configured to display a visual image derived from the captured visual image.

29. A device as claimed in claim 28 wherein the device comprises a processor configured to magnify the captured visual image before display.

30. A device as claimed in claim 28 wherein the device comprises a processor configured to alter the captured visual image before display.

31. A device as claimed in claim 1 wherein the capture element comprises a camera.

32. A device as claimed in claim 31 wherein the camera comprises an electronic camera.

33. A device as claimed in claim 1 wherein the display element comprises an electronic monitor.

34. A device as claimed in claim 33 wherein the display element comprises a housing, the monitor being movable relative to the housing between a stowed configuration and a viewing configuration.

35. A device as claimed in claim 34 wherein the monitor is pivotably movable relative to the housing.

36. A device as claimed in claim 1 wherein the device is portable.

37. A device as claimed in claim 36 wherein the device is configured to be carried in a pocket.

38. A device as claimed in claim 37 wherein the device is sized to be carried in a pocket.

39. A device as claimed in claim 1 wherein the device comprises a source of power for the capture element and/or for the display element, the power source being carried by the device.

40. A device as claimed in claim 39 wherein the power source is rechargeable.

41. A device as claimed in claim 40 wherein the power source is accessible by an external charger to recharge the power source.

42. A device as claimed in claim 39 wherein the power source is fixed in position relative to the device.

43. A device as claimed in claim 42 wherein the power source is housed within at least part of the device.

44. A device as claimed in claim 39 wherein the power source comprises a high capacity battery.

45. A viewing device comprising:
a capture element for capturing a visual image of at least part of a surface; and
a display element for displaying a visual image;
the capture element being movable relative to the display element between a stowed configuration and a reading configuration; and
the capture element being movable relative to the display element between the stowed configuration and a writing configuration.

46. A viewing device comprising:
a capture element for capturing a visual image of at least part of a surface; and
a display element for displaying a visual image;
the display element comprising:
a base side for placement against the surface; and
a display side for displaying the visual image;
the capture element being movable relative to the display element between a stowed configuration and at least one capturing configuration;
in the stowed configuration, a side of the capture element lying substantially in the plane of the base side; and
in the at least one capturing configuration, the capture element being located further from the base side than in the stowed configuration.
